(19) United States
(12) Patent Application Publication
(10) Pub. No.: US 2011/0086333 A1
(43) Pub. Date: Apr. 14, 2011

(54) EDUCATIONAL TOOL FOR LEARNING QUANTUM SCIENCE

(76) Inventor: Haruo MATSUSHIMA, Yamatokooriyama-shi (JP)

(21) Appl. No.: 12/890,982

(22) Filed: Sep. 27, 2010

(30) Foreign Application Priority Data
Oct. 14, 2009 (JP) 2009-252380

(51) Int. Cl. G09B 23/06

(52) U.S. Cl. 434/300

(57) ABSTRACT

A rotational operator is applied once or twice to a product of a wave function of quantum mechanics for a dynamic system and a unit vector in a θ-direction in a polar coordinate system (r, θ, φ) to obtain a first or second vector function, respectively. A starting coordinate is substituted into the first or second vector function to obtain a starting value of the vector function, and a next coordinate a small distance away from the starting coordinate in a direction of the starting value of the vector function is calculated. This process is iterated and segments linking the coordinates one after another are drawn on a medium, such as a sheet, as a magnetic or electric line of force. The process is iterated with replacing the initial starting coordinate with another initial one to obtain another magnetic or electric line of force.

### REFERENCE TO RELATED APPLICATION

This application is based on Japanese patent application serial No. 2009-252380, filed in Japan Patent Office on Oct. 14, 2009. The content of the application is hereby incorporated by reference.

### BACKGROUND OF THE INVENTION

1. Field of the Invention

The present invention relates to an educational tool useful for learning quantum science, and also relates to a producing method thereof.

2. Description of Related Art

It has been warned for a long time that younger people are away from sciences. However, it cannot be said that an effective measure has yet been taken. Although liberal arts handle familiar and approachable subjects, and therefore can easily be approached, sciences have become more and more difficult to understand and approach. Especially, it seems appropriate to say that textbooks on quantum mechanics, which is the most basic one of all sciences, almost describe advanced mathematics rather than the sciences. The sciences in general, and physics as a typical example thereof, are academics that comprehend and explain how material, fluid and electricity function as concretely as possible. It is because mathematics makes expressions more concise or easier to understand than words and sentences that the sciences rely on mathematics. Concrete images should be main players, and mathematical expressions should be backseat ones.

For example, the solution of a differential equation is handled in such a manner that terms that diverge to an infinite value are thrown away, only terms that converge with a finite value are left, and among even and odd functions emerging in the solution, only the even functions are left and the odd ones are thrown away if a concrete system to be analyzed is symmetrical. Thus, a concrete image takes priority over the result of mathematical operation. Further, a concrete image makes the theory easy to approach and interesting.

However, in quantum mechanics, we can only see, as such a concrete image, a drawing of “de Broglie wave” shown in FIG. 50 (a) of non-patent document 1, which is also shown in FIG. 9, and a double circle shown in FIG. 19-6 (b) of non-patent document 2 or the like, which is also shown in FIG. 10, for example. If an extended interpretation is allowed for the “concrete image,” we can also see a graph of density distribution in a radial direction shown in FIG. 61 (2) of non-patent document 1, which is also shown in FIG. 11.

Non-patent document 1 is “Quantum Mechanics II” written by Shinichiro Tomonaga and published by Misuzu Shobo (Japan). Non-patent document 2 is “The Feynman Lectures on Physics, Vols. I, II, III” written by Richard P. Feynman et al., translated by Shigenobu Sunakawa, and published by Iwanami Shoten (Japan).

FIG. 9, which is said to have opened the door to quantum mechanics, shows an electron circulating around a nucleus in a state of wave motion, especially one dimensional endless wave motion. Quantum mechanics was so developed as to successfully explain electron orbitals by use of wave functions and to allow the wave functions to be interpreted as showing probability density of electrons. After the development, quantum mechanics has become away from providing concrete images of wave motions and dominated by the advanced mathematics. FIG. 10, which is a rare example of concrete images, draws the value of a wave function of a 2s orbital on a plane. FIG. 11, which is another example, is a graph showing a probability distribution in a radial direction of the 2s orbital. See these three figures placed one above another.

FIG. 9 shows a wave only in a θ-direction, whereas FIG. 10 shows a wave only in an r-direction. Having a term (2−r/a₀), the wave function of the 2s orbital is positive in r<2a₀, negative in r>2a₀, and has a circular blank region around r=2a₀. Although such wave motion may not be so familiar to us, the mechanism of sound created from a two-dimensional surface of a drum or the like is similar to that shown here, and therefore, the blank, i.e. a node of wave, even having a circular shape, will not cause a feeling of strangeness. FIG. 11 shows an existence probability in a radial direction obtained by squaring the wave function of the 2s orbital and multiplying the radius r thereby. Since a square of zero remains zero, the existence probability is zero at the middle of the blank region in FIG. 10, i.e., at r=2a₀. Since the wave function is expressed in a spherical polar coordinate and a set of points where r=2a₀ forms a spherical surface in the coordinate, FIG. 10 means from a simple view point that the existence probability is zero on the surface and there is no intercommunication of an electron between the inside and the outside of the sphere.

This is still an inconsistency and a problem to be solved. The present invention can also be said to provide solution to the problem. Even if there may not be inconsistency but some interpretation, a certain electro-magnetic field is unquestionably formed in the dynamic system as long as a negatively-charged electron revolves around a positively-charged nucleus. If the shape, amplitude, polarization direction and so on can be determined, it will be effective and advantageous in research and education.

### BRIEF SUMMARY OF THE INVENTION

It is therefore an object of the present invention to solve the above-mentioned conventional problem, and to provide the distribution of an electro-magnetic field of a quantum physical system, such as a hydrogen atom which is the origin of quantum mechanics, to thereby enable an educand to have a concrete image, infer an effect of an applied external magnetic field, and accordingly feel familiar with quantum mechanics, which forms a basic of the sciences.

One aspect of the present invention is directed to a method of producing an educational tool for showing on a medium at least one of magnetic and electric fields in a quantum dynamic system. The method comprises, applying a rotational operator once or twice to a product of a wave function of quantum mechanics for the system and a unit vector in a O-direction in a polar coordinate system (r, θ, φ) to obtain a first or second vector function, respectively. The method further comprises, substituting a starting coordinate into the first or second vector function to obtain a starting value of the vector function, and calculating a next coordinate a small distance away from the starting coordinate in a direction of the starting value of the vector function. The method further comprises, iterating this process to obtain coordinates one after another, and drawing segments linking the coordinates one after another on a medium, such as a sheet, as a magnetic line of force when a first vector function is used, or an electric line of force when a second vector function is used. The method further comprises, iterating the process with replacing the initial starting coordinate with another initial starting coordinate to obtain another magnetic or electric line of force.

The magnetic or electric lines of force provided by the educational tool produced by the method visualize the figure of an atom, i.e., a constitutional unit of material, generate interest in learning sciences among educands, and enable the educands to easily understand that difference in a wave function results in difference in the distribution of a magnetic or electric field and results in difference in the effects of the application of an external magnetic field.

Thus, the educational tool produce by the method of one aspect of the present invention visualizes the figure of an atom constituting material, is useful for a phenomenon analysis, and also generates interest in learning sciences among educands.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view showing magnetic lines of force on a horizontal cross-sectional plane of a 2s orbital drawn in an educational tool according to a first embodiment of the present invention;

FIG. 2 is a plan view showing electric lines of force on a vertical cross-sectional plane of a 2s orbital drawn in an educational tool according to a second embodiment of the present invention;

FIG. 3 is a program list showing partial computer program coded to draw the electric lines of force shown in FIG. 2.

FIG. 4 is a plan view showing magnetic lines of force of a 2s orbital drawn in a perspective view in an educational tool according to a third embodiment of the present invention;

FIG. 5 is a plan view showing magnetic lines of force of a 2pz orbital drawn in a perspective view in an educational tool according to a fourth embodiment of the present invention;

FIG. 6 is a plan view showing magnetic lines of force on a horizontal cross-sectional plane of a 2px orbital drawn in an educational tool according to a fifth embodiment of the present invention;

FIG. 7 is a plan view showing electric lines of force on a vertical cross-sectional plane of a 2px orbital drawn in an educational tool according to a sixth embodiment of the present invention;

FIG. 8 is a flow chart illustrating a procedure of drawing electric lines of force on a medium.

FIG. 9 is a plan view showing an atomic model drawn in a conventional educational tool;

FIG. 10 is a plan view showing a 2s orbital drawn in another conventional educational tool; and

FIG. 11 is a graph showing the probability density of a 2s orbital according to still another conventional educational tool.

### DESCRIPTION OF THE PREFERRED EMBODIMENTS

Hereinafter, preferred embodiments of the present invention will be described with reference to the accompanying drawings. For the simplicity of explanation and understanding, a hydrogen atom will be shown as an example. Therefore, an atomic number Z will be replaced with 1 in wave functions.

### First Embodiment

FIG. 1 illustrates an educational tool according to the first embodiment of the present invention, which shows magnetic lines of force 1 on a horizontal cross-sectional plane of a 2s orbital of a hydrogen atom where θ=90 degrees in a polar coordinate system (r, θ, φ). The 2s orbital, which has the second lowest orbital energy among the wave functions of a hydrogen atom, is expressed as follows with a₀ referred to as the Bohr radius.

(1/32π)^{1/2}(1/a₀)^{3/2}(2−r/a₀)exp(−r/2a₀)

By multiplying this formula by a unit vector in a θ-direction of the polar coordinate system, following expression is obtained.

(1/32π)^{1/2}(1/a₀)^{3/2}(2−r/a₀)exp(−r/2a₀)i_{θ}

Once a rotational operator in a vector space is applied to this formula, a first vector function expressed as follows can be obtained.

(1/32π)^{1/2}(1/a₀)^{3/2}(2/r−3/a₀+r/2a₀²)exp(−r/2a₀)i_{φ}

Here, is a unit vector in a φ-direction. The method of drawing magnetic lines of force shown in FIG. 1 will be described later.

### Second Embodiment

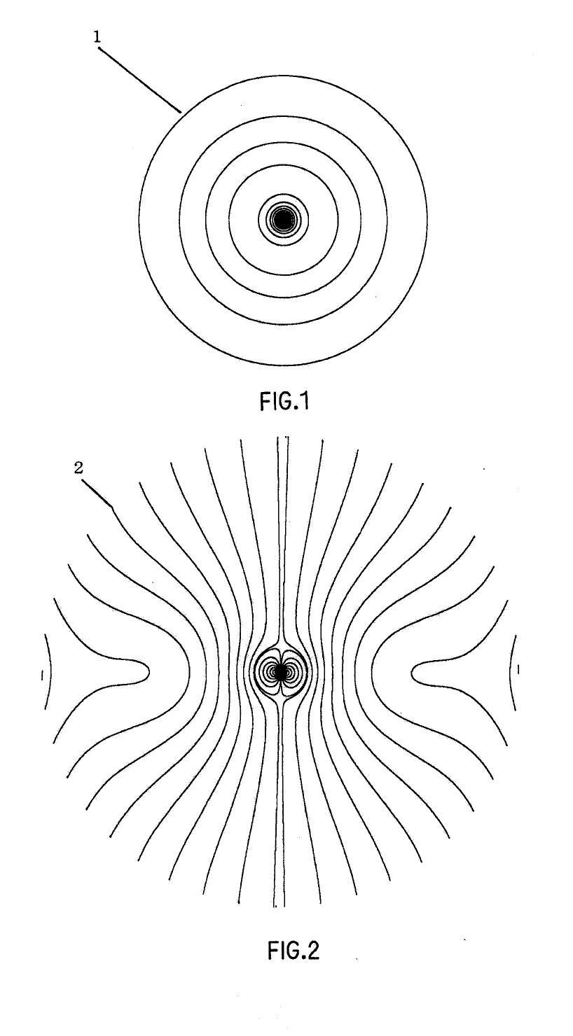

FIG. 2 illustrates an educational tool according to the second embodiment of the present invention, which shows electric lines of force 2 on a vertical cross-sectional plane of a 2s orbital of a hydrogen atom at any value of angle φ. By further applying a rotational operator to the aforementioned first vector function, a second vector function expressed as follows can be obtained.

(1/32π)^{1/2}(1/a₀)^{3/2}exp(−r/2a₀){(2/r²−3/a₀r+1/2a₀²)cot θiᵣ+(4/a₀r−5/2a₀²+r/4a₀³)i_{θ}}

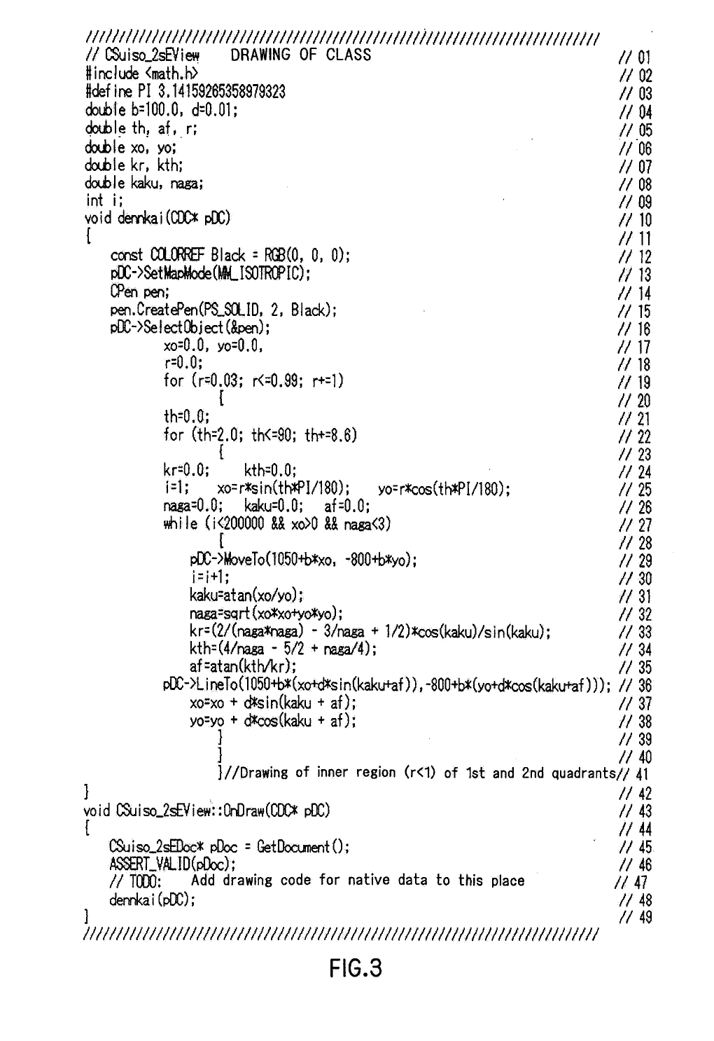

Here, iᵣ is a unit vector in an r-direction. The method of drawing electric lines of force shown in FIG. 2 by use of this function is shown in FIG. 3.

FIG. 3 illustrates a program list showing partial computer program coded to draw the electric lines of force from the second vector function. Line numbers following double slashes are added to the right ends of the lines only for the purpose of explanation in the present application. This program was coded by use of a development tool of Microsoft “Visual C++ 6.0.” Lines 02 to 42 and 48 were added to the ready-made program in the tool for the present embodiment.

The second vector function has components only in r and θ-directions. The r-component of the second vector function at any point (r, θ) on a surface of constant φ is expressed by

(2/r²−3/r+1/2)cot θ

and coded on line 33 of the list. The θ-component thereof is expressed by

(4/r−5/2+r/4)

and coded on line 34.

In these two formulae, the constant a₀ is set at 1 (i.e., a₀=1), and exp(−r/2a₀) is omitted because of being included in the both components as a common factor. You can see r=0.03 on line 19, and θ=2.0 degrees on line 22. This means that a starting coordinate is given a value (0.03, 2.0) initially. Line 25 converts the coordinate system to a normal linear coordinate system (i.e., x, y-coordinate system). The direction of the second vector function is determined on line 35 after performance of aforementioned lines 33 and 34. The next coordinate distant from the starting coordinate in the direction of the second vector function with a small distance d (=0.01) given on line 04 is calculated on lines 37 and 38. The starting and next coordinates are linked with a short linear segment on lines 29 and 36.

The processes from line 25 to line 38 are iterated, and thereby the third coordinate, the fourth coordinate, and so on are calculated. Each coordinate and the next coordinate thereof are linked with a short linear segment during the iteration. When a condition on line 27 is unsatisfied, the process returns to line 22 and another initial coordinate (0.03, 10.6) is given. Thereafter, the same processes are iterated based on the renewed initial coordinate. When a new initial coordinate cannot be found any longer on lines 19 and 22, the process jumps to line 42. As a comment is written on line 41, the above-described processes provide electric lines of force in the first and second quadrants within the range of r<1 (precisely, r<(3−5^{1/2}) roughly equal to 0.76). Another program part is needed between lines 41 and 42 in order to obtain electric lines of force in the range of r>1 and further in the third and fourth quadrants. Such program part is omitted in the list shown in FIG. 3 to avoid complexity. The omitted part is obvious to a skilled person in the art by analogy from the list. FIG. 2 shows electric lines of force in the region of r<6.

Magnetic lines of force such as ones shown in FIG. 1 can also be obtained by the procedure shown in FIG. 3. However, since the first vector function only has a φ-component, it is obvious that magnetic lines of force will form concentric circles. Therefore, the drawing in FIG. 1 was obtained by use of simpler program for drawing circles. In addition, the intervals between adjacent magnetic lines of force in the drawing were determined to be inversely proportional to the absolute value of the vector function so that the density of the magnetic lines of force expresses the absolute value. In FIG. 1, the magnetic lines of force were drawn within the range of r<6 in the same scale as the electric lines of force in FIG. 2. The outer peripheral portion is blank and the outermost circle is present in such an inner region as around r=3.6 in FIG. 1. This is because the function is zero at r=(3+5^{1/2}) roughly equal to 5.2 which is close to the outer periphery of the drawing, and further because the density of the magnetic lines of force has been set low for easy viewability. FIGS. 1 and 2 are placed one above the other in the same scale to clearly show the relation between the magnetic and electric lines of force.

### Third Embodiment

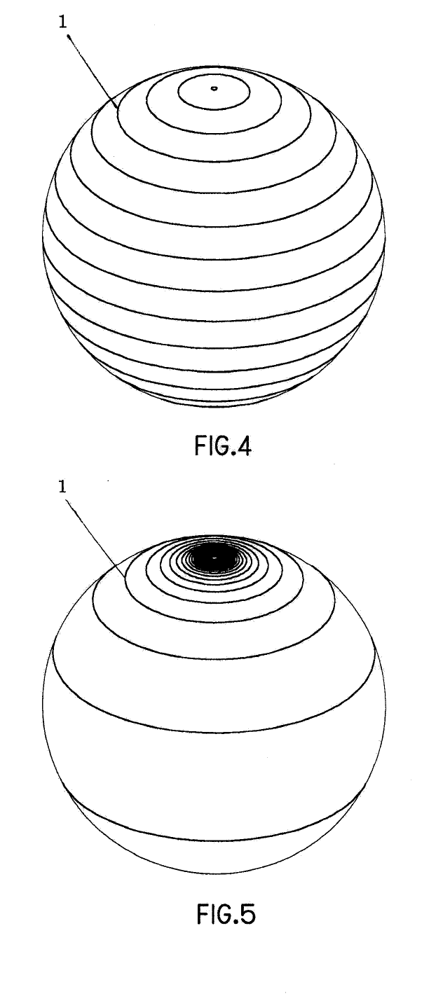

FIG. 4 illustrates an educational tool according to the third embodiment of the present invention, which shows magnetic lines of force 1 of a 2s orbital of hydrogen atom on a spherical surface having a constant radius r drawn in a perspective view on the basis of the first vector function of the 2s orbital. The constant radius r can be any value other than the value r which satisfies a following equation.

2/r−3/a₀+r/2a₀²=0

The magnetic lines of force are similar to latitude lines of the earth, and well known. Explanation on the procedure of drawing the lines is, therefore, omitted.

### Fourth Embodiment

FIG. 5 illustrates an educational tool according to the fourth embodiment of the present invention, which shows magnetic lines of force 1 of a 2pz orbital of hydrogen atom on a spherical surface having a constant radius r drawn in a perspective view on the basis of the first vector function of the 2pz orbital. The first vector function is expressed as follows.

(1/32π)^{1/2}(1/a₀)^{5/2}(2−r/2a₀)cos θexp(−r/2a₀)i_{θ}

The constant radius r can be any value other than the value r which satisfies a following equation.

2−r/2a₀=0

Due to the presence of cos θ as a factor in the function, the absolute value of the function has its maximum value around θ=0 or 180 degrees, and zero around θ=90 degrees.

### Fifth Embodiment

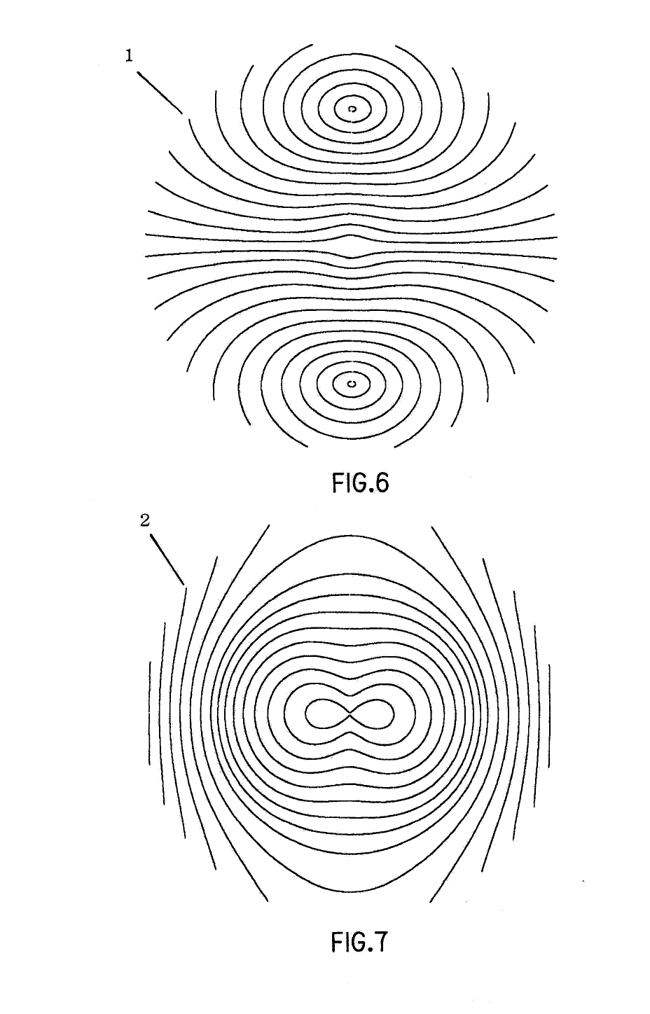

FIG. 6 illustrates an educational tool according to the fifth embodiment of the present invention, which shows magnetic lines of force 1 of a 2px orbital of hydrogen atom on a horizontal cross-sectional plane of θ=90 degrees within a range of r<6 drawn by use of program similar to that in FIG. 3 modifying the function and initial coordinates. The first vector function is expressed as follows.

(1/32π)^{1/2}(1/a₀)^{5/2}exp(−r/2a₀){(2−r/2a₀)sin θ cos φi_{φ}+sin φiᵣ}

### Sixth Embodiment

FIG. 7 illustrates an educational tool according to the sixth embodiment of the present invention, which shows electric lines of force 2 of a 2px orbital of hydrogen atom on a vertical cross-sectional plane where φ=0 and φ=180 degrees within a range of r<6 drawn on the basis of the second vector function of the 2px orbital. The second vector function is expressed as follows.

(1/32π)^{1/2}(1/a₀)^{5/2} cos φexp(−r/2a₀){(4/r−1/a₀)cos θiᵣ+(1/r)/sin θi_{θ}+(2/a₀−2/r−r/4a₀²)sin θi_{θ}}

FIGS. 6 and 7 are placed one above the other in the same scale to clearly show the relation between the magnetic and electric lines of force.

It should be noted that each of the educational tools in accordance with the first to sixth embodiments of the present invention has a medium on which the magnetic or electric lines of force are drawn. The medium is usually a sheet, whereas not limited thereto.

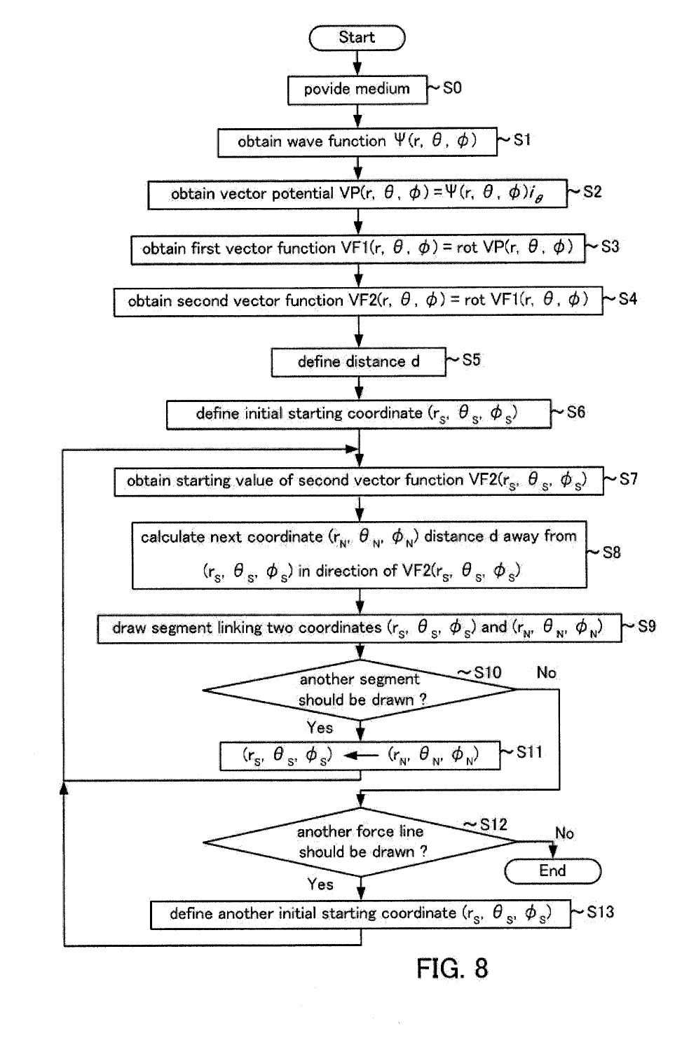

FIG. 8 is a flow chart illustrating a procedure of drawing electric lines of force on a medium. After beginning of this procedure, a medium, such as a sheet, is provided at step S0. A wave function Ψ(r, θ, φ) of a certain quantum dynamic system, such as a hydrogen atom, is obtained at step S1. Next, a vector potential VP(r, θ, φ)=Ψ(r, θ, φ)i_{θ} is obtained by multiplying the wave function Ψ(r, θ, φ) by a unit vector i_{θ} pointing a θ-direction in a polar coordinate system (r, θ, φ) at step S2. A first vector function VF1(r, θ, φ)=rot VP(r, θ, φ) is obtained by applying a rotational operator “rot” to the vector potential VP at step S3. A second vector function VF2(r, θ, φ)=rot VF1(r, θ, φ) is obtained by applying a rotational operator “rot” to the first vector function VF1 at step S4. A small distance d is defined at step S5. An initial starting coordinate (r_{S}, θ_{S}, φ_{S}) is defined at step S6. A starting value of the second vector function VF2(r_{S}, θ_{S}, φ_{S}) is obtained by substituting the starting coordinate (r_{S}, θ_{S}, φ_{S}) into the second vector function VF2(r, θ, φ)) at step S7. A next coordinate (r_{N}, θ_{N}, φ_{N}) that is a distance d away from (r_{S}, θ_{S}, φ_{S}) in a direction of the starting value of the second vector function VF2(r_{S}, θ_{S}, φ_{S}) is calculated at step S8. A segment that links the two coordinates (r_{S}, θ_{S}, φ_{S}) and (r_{N}, θ_{N}, φ_{N}) is drawn on a medium at step S9. It is determined whether another segment should be drawn or not at step S10. A condition coded on lines 19 and 22 of the program illustrated in FIG. 3 provides one example of step S10. If the determination at step S10 is positive, then the starting coordinate (r_{S}, θ_{S}, φ_{S}) is renewed by the next coordinate (r_{N}, θ_{N}, φ_{N}) at step S11. Thereafter, the procedure returns to step S7, and performs steps S7 to S10 again.

If the determination at step S10 is negative, then it is further determined whether another force line should be drawn or not at step S12. If the determination at step S12 is positive, then another initial starting coordinate (r_{S}, θ_{S}, φ_{S}) is defined at step S13. Thereafter, the procedure returns to step S7, and performs steps S7 to S12 again. If the determination at step S12 is negative, then the procedure ends.

A flow chart illustrating a procedure of drawing magnetic lines of force on a medium is provided by omitting steps S4 and replacing the second vector function VF2 with the first vector function VF1 in steps S7 and S8 in FIG. 8.

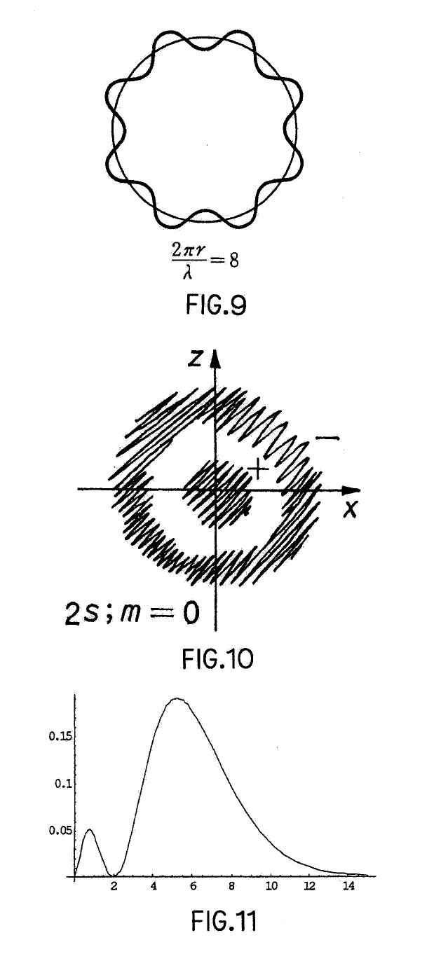

Hereinafter, the operation and function of the educational tools configured as described above will be explained. What is a wave function all about if it does not represent existence probability? From a view point of dynamics, the wave function is a scalar solution of a differential equation derived from balancing Coulomb forces acting between the positive charge of a nucleus and the negative charge of an electron and kinetic or potential energy. On the other hand, from a view point of electro-magnetic fields, three-dimensional stationary wave is foreseen as a combined image of FIGS. 9 and 10. Further, it is known that an electron remains stable without emitting light only on orbitals having discrete angular momenta L=n(h/2π), and the radius r where the existence probability has its maximum value increases with an increase in a quantum number n of the wave function. Combining these facts and the above-stated foresight, we reach an idea that an atom is a kind of lossless resonator and a balance between Coulomb forces and kinetic energy defines a boundary condition of the resonator.

A resonator will allow electrical engineers to utilize well-known method. Even if it is hard to directly obtain electric and magnetic fields as solutions of an equation of electro-magnetic fields because of the presence of six unknown variables, the method reduces the number of the unknown variables by use of a vector potential. The electric and magnetic fields can be calculated from the vector potential obtained as a solution of the equation. For a resonator and a waveguide, a vector potential having a component only in a traveling direction is used.

The traveling wave can be assumed to revolve along a great circle from analogy with an image of an electron revolving around a nucleus. Since only θ is in the direction of the great circle among the polar coordinates (r, θ, φ), a vector potential having a component only in the θ-direction is obtained by multiplying the scalar wave function by a unit vector in the θ-direction, and the electric and magnetic fields are calculated from the vector potential. This is the essence of the present invention. Examination will hereinafter be provided on whether this idea is correct or not.

One of magnetic and electric fields varies sinusoidally whereas the other varies cosinusoidally inside a resonator, and the total energy of the two fields always maintains a constant value. As a result, once the distribution of one of the two fields is found, the total energy can be calculated. The whole space integration of the square value of the magnetic field of each orbital is partly shown below.

1st orbital—(μ₀/2)/a₀²

2nd orbital—(μ₀/2)/a₀²/4

3rd orbital—(μ₀/2)/a₀²/9

4th orbital—(μ₀/2)/a₀²/16

Next, general ns orbitals will be discussed. A normalized energy eigenfunction u_{n, l, m} of a hydrogen atom is well known, and is, for example, seen in p. 107 of “Quantum Mechanics (I) (New Edition)” written by Leonard I. Shiff, translated by Ken Inoue, and published by Yoshioka Shoten (Japan). Substituting l=m=0 to the eigenfunction u_{n, l, m} brings a wave function of an ns orbital as follows.

u_{nα0}=−Aexp(−ρ/2)L¹ₙ(ρ)

Here,

A={(2/na₀)³(n−1)!/2n[n!]³}^{1/2}

ρ=2r/na₀

L¹ₙ(ρ)=Σⁿ⁻¹ₖ₌₀(−1)^{k+1}{[n!]²ρ^{k}}/{(n−1−k)!(k+1)!k!}

The first vector function is therefore expressed by a following formula.

i_{φ}/rd/dr{−rAexp(—ρ/2)L¹ₙ(ρ)}

This function represents a magnetic field H. Total energy of a lossless resonator is expressed as follows.

W=μ₀/2∫ᵥ∥H∥²dv

The total energy of the ns orbital is, therefore, expressed as follows.

W=μ₀/2∫[1/rd/dr{rAexp(−ρ/2)L¹ₙ(ρ)}]²r² sin θdrdθdφ

Here,

L¹ₙ(ρ)=d/dρ{exp(ρ)dⁿ/dρⁿρⁿexp(−ρ)}

First, following two integral values are calculated.

∫₀^{π} sin θdθ=2

∫₀^{2π}dφ=2π

Next, partial integration is performed over r, and thereby a following formula is obtained.

W/A²4πμ₀/2=[{r·exp(−ρ/2)L¹ₙ(ρ)}d/dr{r·exp(−ρ/2)L¹ₙ(ρ)}]₀^{∞}−∫₀^{∞}[r·exp(−ρ/2)d/dρ{exp(ρ)dρⁿρⁿexp(−ρ)}]d²/dr²{r·exp(−ρ/2)L¹ₙ(ρ)}dr

When r or ρ approaches infinity,

exp(−ρ/2),

dⁿ⁻¹/dρⁿ⁻¹ρⁿexp(−ρ),

and the like approach zero. Taking these ultimate values and the relation between dr and dρ into consideration, partial integration is iterated. As a result, only a term of a first-power of ρ of

{[n!]²ρ^{k}}/{(n−1−k)!(k+1)!k!}

and two constant terms finally remain. Consequently, energy of the ns orbital is obtained as follows.

W=(1/a₀²)μ₀/2/n²

This formula does not look so meaningful. However, once being multiplied by 2/μ₀ to remove μ₀/2 which came out during the energy calculation, and multiplied by a coefficient

−h²/2mₑ

which frequently appears in quantum mechanics, the formula is rewritten as follows.

W=−mₑe⁴/{(8εₒ²h²)n²}

This formula is well known as the Bohr's energy level. Thus, the energy level of a hydrogen atom is derived directly without use of complicated Dirac's equation. This validates the proposition that a wave function is a θ-component of a vector potential, which is the essence of the present invention.

Next, magnetic nature will be reviewed. The magnetic lines of force on 2s and 2pz orbitals are formed of closed circles as shown in FIGS. 1, 4 and 5, whereas those of a 2px orbital are opened toward right and left sides as shown in FIG. 6. Even if the atom is placed within an external static magnetic field, the 2s or 2pz orbital may only show small effects depending on the direction of the circular magnetic lines of force, i.e., clockwise or anticlockwise. In contrast, the 2px orbital is expected to turn over like a compass responding to the geomagnetism.

A general form of a wave function is expressed as follows, referring to Rₙₗ(r) as a function only of r, Θₗₘ(θ) as only of θ, and Φₘ(φ) as only of φ.

ψₙₗₘ(r,θ,φ)=Rₙₗ(r)·θₗₘ(θ)·φₘ(φ)

Magnetic field is expressed by

$$\begin{matrix}{H}_{nIm} = Curl {R}_{ni} ( r ) \cdot {⊖}_{Im} ( θ ) \cdot {Φ}_{n} ( φ ) {i}_{θ} \\ = {i}_{θ} / r \cdot \partial / \partial r \{ r \cdot {R}_{ni} ( r ) \cdot {⊖}_{Im} ( θ ) \cdot {Φ}_{m} ( φ ) \} - \\ {i}_{r} / ( {r}^{2} sin θ ) \cdot \partial / \partial φ \{ r \cdot {R}_{nI} ( r ) \cdot {⊖}_{Im} ( θ ) \cdot {Φ}_{m} ( φ ) \} \\ = {i}_{φ} / r \cdot {⊖}_{Im} ( θ ) \cdot {Φ}_{m} ( φ ) \cdot \partial / \partial r \{ r \cdot {R}_{nI} ( r ) \} - \\ {i}_{r} / ( r sin θ ) \cdot {R}_{nI} ( r ) \cdot {⊖}_{Im} ( θ ) \cdot \partial / \partial φ \{ {Φ}_{m} ( φ ) \}\end{matrix}$$

$$Here , \\ {Φ}_{m} ( φ ) = {( 2 )}^{- 1 / 2} exp ( im φ ) .$$

When m=0, Φₘ is a constant, and therefore, the differentiation thereof is zero, resulting in the magnetic field having no r-component but only having a φ-component similarly to that of the 2s or 2pz orbital. The force lines thereof are fundamentally formed of closed circles. In contrast, when m is not zero, the magnetic field has an r-component, and the force lines thereof are complex and opened like those of the 2px orbital. This can be regarded as a cause of spin.

As the last part of the explanation on the functions or actions, the velocities of both the electromagnetic wave and the electron present inside the resonator will be described. Mass of photon is supposed to be zero in quantum mechanics. For the same reason, an electron having mass cannot reach the light velocity. Therefore, it should be thought that the electromagnetic wave revolves an integer number of times when the electron makes one revolution, and the two synchronize with each other. However, the integer number is unknown, and a mechanism of energy exchange between the electron and the electromagnetic wave remains as an unsolved problem. If an electron revolves as wave motion at the light velocity, the problem will be solved.

In accordance with the theory of special relativity, at the light velocity, not only mass reaches the infinity, but also a length in a traveling direction and progress of time become zero. This teaching of the theory should require photons to show no time progress because they travel at the light velocity. If it does, it will be a problem how difference occurs in frequency of electromagnetic wave, such as difference between purple and red colors of visible light, and difference between gamma ray and micro wave. Since the difference is due to difference in one cycle time, the difference cannot occur without progress of time. This is a serious inconsistency.

A pocketbook “Relativistic Theory,” which is a collection of Einstein's articles, translated and provided with a commentary by Ryoyu Uchiyama, and published by Iwanami Shoten (Japan) in 1988, in a section thereof titled “I. Kinetics §3: Theory of coordinates and time conversion from static coordinate system to another coordinate system moving uniformly and translationally with respect to the static one,” reads “ . . . , suppose that the origin of a coordinate system (k) moves in a positive direction of an X-axis of the other static coordinate system (K) at a velocity v with respect to the system (K) . . . . Now, suppose that light is emitted from the origin of the system (k) along the X-axis of the system (k) toward a certain point fixed on the X-axis at a time τ₀. We refer to the time when the light arrives and is reflected immediately at the fixed point as τ₁, and the time when the reflected light returns to the origin of the system (k) as τ₂ . . . .” If the constant velocity v is identical with the light velocity, the light emitted from the origin never reaches the fixed point traveling away at the same light velocity. Thus, the Einstein's relativistic theory is only applicable to a system having a lower velocity than the light velocity, and therefore, it is natural that an application of the theory to photons creates inconsistency.

As described above, the essence of the present invention not only has no inconsistency, but also explains the energy levels and the spins without help of complicated mathematical methods. Although the essence contradicts the fundamental principle of quantum mechanics “wave function represents existence probability,” this proposition itself has inconsistency as stated above, and the essence provides new solution to the inconsistency.

Further, lack of educational tools like those in accordance with the present invention which provide concrete images allowed the theory that only relies on advanced mathematics to have been formed and have proceeded with inconsistency embraced.

As described above, the preferred embodiments of the present invention advantageously raise educands' interest in sciences, and especially quantum mechanics, with the drawings of the internal structure of an atom and help to prevent them from going away from sciences, and furthermore, prevent their misunderstanding that can be caused by inference only weighted in mathematics. In addition, the embodiments allow the educands to easily understand the relation of a hydrogen atom with its external magnetic field. The embodiments further enable the energy levels of a hydrogen atom to be calculated from the distribution of the magnetic field, and are expected to contribute to quantum electromagnetic theory.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

As described above, the educational tool in accordance with the present invention visualizes the figure of a quantum physical system, such as a hydrogen atom, enables educands to have a close feeling toward hardly understood or approached sciences and quantum mechanics, prevents them from going away from sciences, enables them to have an image of phenomenon occurring under the application of an external static magnetic field, and is therefore useful for education and research.

What is claimed is:

1. A method of producing an educational tool for showing on a medium a magnetic field in a quantum dynamic system, comprising:
(a) obtaining a wave function of quantum mechanics for the dynamic system;
(b) multiplying the wave function by a unit vector pointing a θ-direction in polar coordinate system (r, θ, φ) to obtain a vector potential;
(c) applying a rotational operator to the vector potential once to obtain a vector function;
(d) defining a starting coordinate;
(e) substituting the starting coordinate into the vector function to obtain a starting value of the vector function;
(f) calculating a next coordinate a certain distance away from the starting coordinate in a direction of the starting value of the vector function;
(g) drawing a segment linking the starting and the next coordinates as part of a magnetic line of force on the medium;
(h) referring to the next coordinate as the starting coordinate, and performing (e) to (g) once again;
(i) iterating (h) to obtain a continuous magnetic line of force on the medium; and
(j) performing (d) to (i) at least once again, redefining the starting coordinate differently at each (d) to obtain magnetic lines of force on the medium.

2. The method according to claim 1, wherein the wave function is a wave function of one of orbitals of a hydrogen atom.

3. The method according to claim 2, wherein the one of orbitals is one of 2s, 2px, 2py and 2pz orbitals.

4. The method according to claim 2, wherein the magnetic lines of force are drawn in a perspective view.

5. The method according to claim 2, wherein the magnetic lines of force are so drawn to express the magnetic field on a cross-sectional plane defined by 90 degrees of θ.

6. A method of producing an educational tool for showing on a medium a electric field in a quantum dynamic system, comprising:
(a) obtaining a wave function of quantum mechanics for the dynamic system;
(b) multiplying the wave function by a unit vector pointing a θ-direction in polar coordinate system (r, θ, φ) to obtain a vector potential;
(c) applying a rotational operator to the vector potential twice to obtain a vector function;
(d) defining a starting coordinate;
(e) substituting the starting coordinate into the vector function to obtain a starting value of the vector function;
(f) calculating a next coordinate a certain distance away from the starting coordinate in a direction of the starting value of the vector function;
(g) drawing a segment linking the starting and the next coordinates as part of an electric line of force on the medium;
(h) referring to the next coordinate as the starting coordinate, and performing (e) to (g) once again;
(i) iterating (h) to obtain a continuous electric line of force on the medium; and
(j) performing (d) to (i) at least once again, redefining the starting coordinate differently at each (d) to obtain electric lines of force on the medium.

7. The method according to claim 6, wherein the wave function is a wave function of one of orbitals of a hydrogen atom.

8. The method according to claim 7, wherein the one of orbitals is one of 2s, 2px, 2py and 2pz orbitals.

9. The method according to claim 7, wherein the electric lines of force are drawn in a perspective view.

10. The method according to claim 7, wherein the electric lines of force are so drawn to express the magnetic field on a cross-sectional plane defined by a certain value X of φ and X+180 degrees of φ.

11. A method of producing an educational tool for showing on a medium magnetic and electric fields in a quantum dynamic system, comprising:
(a) obtaining a wave function of quantum mechanics for the dynamic system;
(b) multiplying the wave function by a unit vector pointing a θ-direction in polar coordinate system (r, θ, φ) to obtain a vector potential;
(c) applying a rotational operator to the vector potential once to obtain a first vector function;
(c1) applying a rotational operator to the first vector function once to obtain a second vector function;
(d) defining a starting coordinate;
(e) substituting the starting coordinate into the first vector function to obtain a starting value of the first vector function;
(f) calculating a next coordinate a certain distance away from the starting coordinate in a direction of the starting value of the first vector function;
(g) drawing a segment linking the starting and the next coordinates as part of a magnetic line of force on the medium;
(h) referring to the next coordinate as the starting coordinate, and performing (e) to (g) once again;
(i) iterating (h) to obtain a continuous magnetic line of force on the medium;
(j) performing (d) to (i) at least once again, redefining the starting coordinate differently at each (d) to obtain magnetic lines of force on the medium;
(d1) defining another starting coordinate;
(e1) substituting the another starting coordinate into the second vector function to obtain a starting value of the second vector function;
(f1) calculating a next coordinate a certain distance away from the another starting coordinate in a direction of the starting value of the second vector function;
(g1) drawing a segment linking the another starting coordinate and the next coordinate obtained at (f1) as part of an electric line of force on the medium;
(h1) referring to the next coordinate as the another starting coordinate, and performing (e1) to (g1) once again;
(i1) iterating (h1) to obtain a continuous electric line of force on the medium; and
(j1) performing (d1) to (i1) at least once again, redefining the another starting coordinate differently at each (d1) to obtain electric lines of force on the medium.

12. The method according to claim 11, wherein the wave function is a wave function of one of orbitals of a hydrogen atom.

13. The method according to claim 12, wherein the one of orbitals is one of 2s, 2px, 2py and 2pz orbitals.

14. The method according to claim 12, wherein the magnetic lines of force and the electric lines of force are drawn in a perspective view.
